(19) United States
(12) Patent Application Publication
(10) Pub. No.: US 2026/0195004 A1
(43) Pub. Date: Jul. 9, 2026

(54) Display System and Electronic Device

(71) Applicants: Analogix (Suzhou) Semiconductor CO., LTD., Suzhou, Jiangsu (CN); ANALOGIX INTERNATIONAL LLC

(72) Inventors: Fangzheng GUO, Suzhou, Jiangsu (CN); Yuzhi CHEN

(21) Appl. No.: 18/294,171

(22) PCT Filed: Aug. 10, 2023
(86) PCT No.: PCT/CN2023/112344

§ 371 Date: Feb. 1, 2024

(30) Foreign Application Priority Data
Jul. 31, 2023 (CN) 202310953562.7

(51) Int. Cl. G06F 3/041; G06F 3/04886

(52) U.S. Cl. CPC G06F 3/0416; G06F 3/04886

(57) ABSTRACT

The present application provides a display system and an electronic device. The display system includes a control component and a display component, wherein the control component is configured to send a control instruction; and the display component, which is in direct communication connection with the control component, includes a storage module, wherein the storage module is configured to store target display information, and the display component is configured to receive the control instruction sent by the control component, and acquire and display the target display information of the storage module according to the control instruction. The control component directly communicates with the display component, so that the display component directly calls storage information in the storage module and displays the storage information, thereby solving the problem of an image delay affecting the user experience.

### CROSS-REFERENCE TO RELATED APPLICATION

The present application claims the priority of Chinese patent application no. 202310953562.7, filed with the China National Intellectual Property Administration on Jul. 31, 2023 and entitled “Display System and Electronic Device”, which is incorporated herein by reference in its entirety.

### TECHNICAL FIELD

The present application relates to the field of touch-control display, and in particular to a display system and an electronic device.

### BACKGROUND

At present, more and more screens support touch control, and a local image needs to be updated sequentially passing through a touch screen, a touch-control sensor, a mainboard controller, a central processing component (CPU for short), a graphics card, a display chip and a display screen. Therefore, the delay for updating a touch-control image may be up to several frames, thus affecting the user experience.

Therefore, there is an urgent need for a display system to solve the problem of delay for updating the touch-control image.

### SUMMARY

According to one aspect of the present application, provided is a display system, including: a control component, configured to send a control instruction; and a display component, in direct communication connection with the control component, and including a storage module, wherein the storage module is configured to store target display information, and the display component is configured to receive the control instruction sent by the control component, and acquire and display the target display information of the storage module according to the control instruction.

In some embodiments, the system further includes: a touch-control component, in communication connection with the control component, and configured to receive a touch-control signal, convert the touch-control signal into touch-control information, and send the touch-control information to the control component, wherein the touch-control information at least includes touch-control position information.

In some embodiments, the control component is configured to receive information, and generate the control instruction on the basis of the touch-control information.

In some embodiments, acquire and display the target display information of the storage module according to the control instruction includes: the target display information is displayed in a target area of the display component according to the control instruction, wherein the target area is a projection area, on the display component, of a touch-control area corresponding to the touch-control position information.

In some embodiments, displaying the target display information in the target area of the display component according to the control instruction includes: historical display information of the target area of the display component is updated, and the target display information is displayed in the target area of the display component.

In some embodiments, displaying the target display information in the target area of the display component according to the control instruction further includes: the serial number of the target display information in the storage module is updated.

In some embodiments, the display component includes: a logic board, configured to acquire the target display information of the storage module, as well as receive the control instruction, and convert the control instruction into a driving signal; and a display module, in communication connection with the logic board, and configured to receive the driving signal, and display the target display information of the storage module according to the driving signal.

In some embodiments, the display component includes a logic board, and the control component is further configured to set a communication protocol between the logic board and the control component, so that the control component is in direct communication connection with the display component.

In some embodiments, the target display information includes at least one of the following: virtual keyboard information; cursor information; and temperature information of the control component.

According to another aspect of the present application, provided is an electronic device, including: any one of the systems.

### BRIEF DESCRIPTION OF THE DRAWINGS

The drawings, which constitute a part of the present application, are used to provide a further understanding of the present application, and the schematic embodiments of the present application and the description thereof are used to explain the present application, and do not constitute an improper limitation on the present application. In the drawings:

FIG. 1 illustrates a structural block diagram of a display system according to an embodiment of the present application; and

FIG. 2 illustrates a structural block diagram of a display system according to an embodiment of the present application.

The above drawings include the following reference signs:
10. control component; 20. display component; 21. storage module; 30. touch-control component.

### DETAILED DESCRIPTION OF THE EMBODIMENTS

It should be noted that, in the case of no conflict, the embodiments in the present application and features in the embodiments may be combined with each other. The present application will be described in detail below with reference to the drawings and in combination with the embodiments. In order to make those skilled in the art better understand the solutions of the present application, a clear and complete description of the technical solutions in the embodiments of the present application will be given below, in combination with the drawings in the embodiments of the present application. Apparently, the embodiments described below are merely a part, but not all, of the embodiments of the present application. All of other embodiments, obtained by those ordinary skilled in the art based on the embodiments in the present application without any creative effort, fall into the protection scope of the present application.

It should be noted that, the terms “first” and “second” and the like in the specification, claims and the above drawings of the present application are used for distinguishing similar objects, and are not necessarily used for describing a specific sequence or precedence order. It should be understood that the data used in this way may be interchanged under appropriate circumstances, so as to describe the embodiments of the present application herein. In addition, the terms “including” and “having”, and any variations thereof are intended to cover non-exclusive inclusions, for example, processes, methods, systems, products or devices including a series of steps or components are not necessarily limited to those clearly listed steps or components, but may include other steps or components that are not clearly listed or are inherent to these processes, methods, products or devices.

For ease of description, some nouns or terms involved in the embodiments of this application are described below:
A TCON: a screen display control chip is simply referred to as a TCON, which refers to a main control chip that is located on a screen display logic board for controlling a driving display screen or a touch-control display screen. The TCON is configured to receive a display control signal and performing decoding processing on the same. The TCON accepts pixel data, a time-sequence control signal and the like, which are emitted from a mainboard or a display controller, and performs parsing processing to generate pixel data and a control signal, which are used for driving the display screen. The TCON drives the display screen to provide the pixel data and the time-sequence control signal, so as to implement image display. The TCON is responsible for generating and emitting RGB, QVGA, or other pixel data signals, a row synchronization signal HSYNC, a row signal VSYNC and other driving time-sequence control signals according to the parsed display control signal, so that the display screen achieves the effect of correctly displaying images. The TCON supports the driving and detection of a touch screen. The TCON is not only responsible for the generation of the pixel data and the control signal of the display screen, but also performs scanning, decoding and processing on the touch screen, so that the touch screen achieves the function of normally responding to the touch of a user, and the functions mainly includes capacitance data scanning and bus conversion of a capacitive touch screen. The TCON is customized according to specific screen technologies and parameters or is designed by selecting a universal chip. The main screen technologies involved include a TFT-LCD, an OLED and the capacitive touch screen, and so on, and the TCONs corresponding to different technologies may have a certain difference.

A touch-control IC: the touch-control IC is also referred to as a touch chip or a touch-control integrated circuit, and refers to an electronic chip that implements a touch-control detection function. The touch-control IC is a key component for enabling a touch-control screen and a touch-control device to normally respond to the touch of the user and detecting the touch of the user. The touch-control IC integrates a detector related to related technologies such as capacitance, infrared, surface acoustic waves, and the like, and is used for detecting a contact condition between a finger of the user or a touch tool and the touch-control screen or the touch-control device, and generating a corresponding electrical signal, so as to locate the touch control. By means of analyzing a detection signal, the touch-control IC may reckon a specific touch position and a continuous touch trajectory of the user, so as to support a touch-control application program to correctly return a touch-control point, thereby realizing an accurate touch-control response. A standardized output interface is provided. Multi-point touch control with better operability is gradually promoted and applied in the current mainstream products. The touch-control IC needs to simultaneously detect a plurality of contact points of the user and accurately return the same, so as to meet the requirements of multi-point touch control. In addition, some touch-control ICs support the recognition and classification of touch-control behaviors such as different strengths and durations, or recognition of intuitive gestures.

A touch-control sensor: the touch-control sensor refers to a device used for detecting a tactile input of the user, and is mainly used for implementing a touch-control function of the touch-control screen and the touch-control device. Common touch-control sensors include capacitive touch screen sensors, touch-resistant screen sensors, surface acoustic wave touch screen sensors, infrared touch screen sensors, and the like. The capacitive touch screen sensor uses a variable container to constitute a capacitance network, a capacitance value is changed by the touch of the user, and thus the touch is detected. This method has the advantages of quick response and low cost, and has the disadvantage of poor durability. The touch-resistant screen sensor forms a grid circuit on the display screen, a resistance value of the circuit is changed by the touch of the user, and thus the touch is detected. This method has the advantages of being high in durability and difficult to be damaged, and has the disadvantages of high cost and slow response. The surface acoustic wave touch screen sensor emits high-frequency acoustic waves around the display screen, and the reflection of the acoustic waves is detected by the detector due to the touch of the user. This method has the advantages of being high in durability and difficult to be distributed or affected, and has the disadvantages of high cost, large volume and little worse sensitivity than that of a capacitive touch screen. The infrared touch screen sensor is provided with infrared rays or emitters at the periphery of a display, and the shielding of the infrared rays is detected by an infrared detector due to the touch of the user. This method has the advantages of being high durability and being unlikely to be affected by the environment, and has the defects of high cost, high space occupancy and limited operation temperature.

A mainboard controller: the mainboard controller refers to an electronic component on a mainboard, which is used for implementing a basic control function of the system.

A graphics card: the graphics card is also referred to as a graphics card or display card, and is an important device of a computer system for displaying images and processing the images. The graphics card has the following main functions: processing image data. The graphics card has a dedicated image processing component, which may perform, on the images, various image processing operations such as sampling, compression, decoding, coloring, rendering and the like, thereby realizing the display and real-time rendering of the images. The computing power of the image processing component directly affects the display effect and the game experience. The graphics card may implement image output of the display screen. The graphics card supports interfaces of different display standards, such as VGA, DVI, HDMI, Display Port and son on, and may output the processed image data to an external display, a television and other display devices by means of these interfaces, so as to display the images. Different graphics cards support different display technologies, such as 2D or 3D images, resolutions, pixel rates, update rates, and the like. It is required that the display and the graphics card support the same display technology standard, so as to achieve an ideal display effect. The graphics card owns an independent image processing component, and thus may independently process complex operations related to the images, thereby sharing the load of a central processing component and improving the overall operation performance of the system.

As described in the background art, an image delay affects the user experience in the prior art, and in order to solve the above problem, the embodiments of the present application provide a display system and an electronic device.

The technical solutions in the embodiments of the present application will be clearly and completely described below in combination with the drawings in the embodiments of the present application.

The present embodiment provides a display system. As used below, the term “module” is a combination of software and/or hardware, which may implement predetermined functions. Although the apparatus described in the following embodiments is preferably implemented in software, implementations of hardware, or a combination of software and hardware are also possible and conceivable.

The display system provided in the embodiment of the present application will be described below.

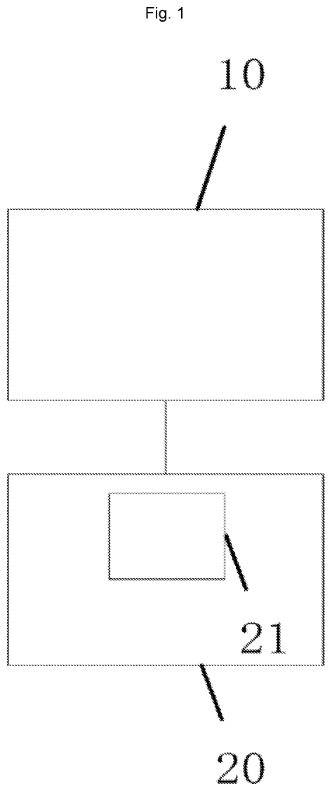

FIG. 1 is a schematic diagram of a display system according to an embodiment of the present application. As shown in FIG. 1, the apparatus includes:
a control component 10, configured to send a control instruction; and
specifically, the control instruction sent by the control component may be a screen updating control instruction, a brightness control instruction, a color setting instruction, a display area setting instruction, a display mode setting instruction and a parameter query instruction, wherein the screen updating control instruction is used for controlling a refresh frequency and a refresh mode of a display. The instruction may set parameters such as a refresh interval, a refresh direction (vertical refresh or horizontal refresh), a scanning area range, and the like, so as to implement a customized display updating policy, thereby improving the display performance and reducing the power consumption of the display. The brightness control instruction is used for controlling a brightness level and a contrast of the display. Different brightness settings correspond to different light source powers, and the instruction may flexibly adjust the brightness of the display according to ambient light changes or user experience, so as to achieve an optimal visual display effect. The color setting instruction is used for setting the hue and the saturation of color channels (three primary colors, namely, red, green and blue) of the display. The instruction allows flexible adjustment on the color output capability of the display, implements rich and diverse color display effects, and improves the user experience. The display area setting instruction is used for setting the size and position of the actual display content of the display. The instruction may control an equivalent block range of the display content by means of defining a top left point and a lower right point, so as to customize a display proportion and a layout mode of the display content. The display mode setting instruction is used for setting a display mode of the display, such as monochrome display, color display, high-color display, and the like. Different display modes correspond to different pixel form color spaces, and the instruction may flexibly switch the display mode of the display, so as to meet diversified display requirements of the user. The parameter query instruction is used for querying important display parameters of the display, such as color number, color depth, pixel density, and the like. By means of actively querying these critical parameters, the system may confirm whether the current display capability of the display have reached or exceeded design requirements and make adjustments in time. This is crucial to optimizing the display effect and taking into account the performance.

A display component 20, in direct communication connection with the control component 10, and including a storage module 21, wherein the storage module 21 is configured to store target display information, and the display component 20 is configured to receive the control instruction sent by the control component 10, and acquire and display the target display information of the storage module 21 according to the control instruction.

Specifically, the display component may be a liquid crystal display, an organic light-emitting diode display, an electric disk display, or a touch screen display. The liquid crystal display (LCD for short) is the most ordinary and common display type. An image is displayed by means of controlling the arrangement of liquid crystal molecules, and the liquid crystal display has the characteristics of being thin, light-weight and low energy consumption. Mainstream LCD resolutions include: WVGA, QVGA, VGA, WVGA, FWVGA, and the like. The organic light-emitting diode display (OLED for short) emits light by means of an organic charge transport layer, so as to display an image, and has the advantages of high contrast, short response time, wide angle of view, and the like. The OLED is mainly applied to high-end mobile phones and tablet computers. An electronic ink display displays an image by means of controlling the movement of charges in an oil separation layer, has the advantages of high contrast, low energy consumption and the like, but has a relatively low refresh rate, and is mainly applied to electronic books at present. Compared with common displays, a touch screen supports touch-control input of display content, and generally uses several display technologies described above to match a touch panel. The specific technology of the touch panel includes resistive, capacitive, infrared, and the like. The touch screen is widely used in display designs, and is applied to mobile phones, tablet computers, mobile phones, and the like. The storage module may be a Flash memory.

The present embodiment provides a display system. The display system includes a control component and a display component, wherein the control component is configured to send a control instruction; and the display component, which is in direct communication connection with the control component, includes a storage module, the storage module is configured to store target display information, and the display component is configured to receive the control instruction sent by the control component, and acquiring and displaying the target display information of the storage module according to the control instruction. The control component directly communicates with the display component, so that the display component directly calls storage information in the storage module and displays the storage information. In this way, the display system does not rely on a graphics card to output data, thereby solving the problem of an image delay affecting the user experience.

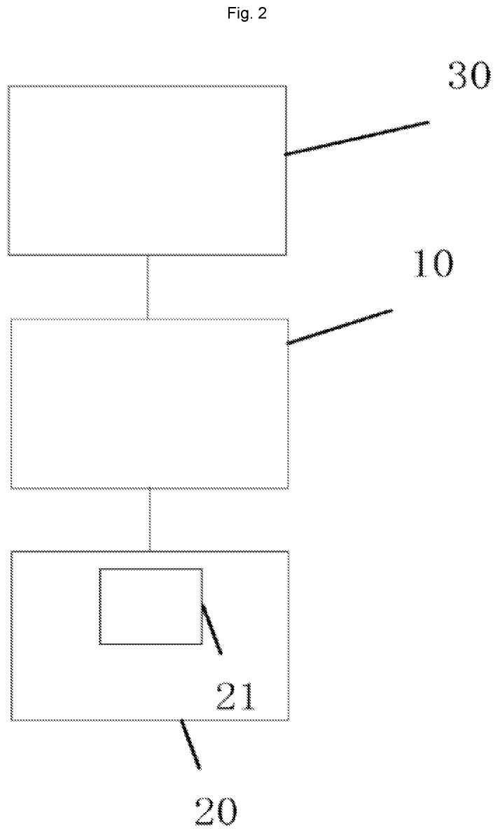

In a specific implementation process, as shown in FIG. 2, the display system further includes a touch-control component 30, in communication connection with the control component 10, and configured to receive a touch-control signal, convert the touch-control signal into touch-control information, and send the touch-control information to the control component 10, wherein the touch-control information includes at least touch-control position information. The system is further applicable to the field of touch-control display.

Specifically, the display component is responsible for actually displaying images and content. Generally, the liquid crystal display (LCD), the organic light-emitting diode display (OLED) and other technologies are used to display an image by means of controlling pixels, light or liquid crystals. The display refreshes, updates and displays the image by means of instructions of a mainboard controller. The touch-control component is installed in front of or behind the display, and is configured to detect a touch-control input of the user and converting same into an electrical signal. The current mainstream touch-control panel technologies include resistive, capacitive and infrared rays, which respectively detect a touch by means of changing a resistance value, a capacitance value or absorbing infrared rays, and transmit a detection signal to the mainboard controller for processing. The mainboard controller not only controls the display of the display, but also is responsible for receiving and explaining the touch-control signal of a touch-control panel and generating a corresponding system response. For example, upon detecting the displacement or release of a touch point of the user on the touch screen, the mainboard controller identifies the position and coordinate information of the corresponding touch-control point, and drives the display to update the content so as to respond to the user operation. In addition, the mainboard also performs reset, calibration and parameter optimization on the touch-control system to ensure the normal operation thereof.

The control component of the present application is configured to receive the touch-control information, and generate the control instruction on the basis of the touch-control information. The system may further quickly generate the control instruction.

Specifically, after receiving the coordinate information of the touch-control point, the mainboard controller needs to determine the display content or control corresponding to the touch-control point. If discovering the corresponding control, the mainboard controller also sends identification information of the corresponding control. According to the identified control information, the mainboard controller generates a corresponding control instruction for operation. For example, for a text box or a list box, the instruction may be setting a cursor position, or selecting characters, etc. For a button, the instruction may be simulating to press or release the button. For a form control, the instruction may be inputting characters or selecting an option, etc. For a picture object, the instruction may be modifying attributes such as position, size, color and the like of the object. The mainboard controller transmits the generated control instruction to other components for execution, so as to complete a device operation required by human-computer interaction. The above steps are repeated, and the system continues to generate and execute related control instructions according to subsequent touch-control operations of the user, and responds to the interaction of the user in real time, so as to construct richer user experience.

The display component is further configured to display the target display information in a target area of the display component according to the control instruction, wherein the target area is a projection area, on the display component, of a touch-control area corresponding to the touch-control position information. The system may accurately locate the touch-control area and further display the touch-control area.

Specifically, the touch-control component detects the touch-control position information of the user and converts the same into an electrical signal, and then converts the electrical signal into coordinate information of the touch-control point and transmits the coordinate information to the mainboard controller by means of an interface. In general, the touch-control panel is located above the display panel, which is simple and practical, and is suitable for a common touch screen display. The touch-control panel is located on the surface of the display screen, and the user directly senses the content of the display screen and the current display state of the display screen by means of touching a position on the panel, thereby realizing a direct visual and tactile correspondence, and thus the user experience is relatively intuitive and natural.

In some embodiments, the display component is further configured to update historical display information of the target area of the display component, and display the target display information in the target area of the display component. The system may further update the historical display information.

Specifically, the historical display information may be updated in the following manner, for example, text content and image display are updated by means of modifying a pixel value. The display is updated by means of setting the RGB value of each pixel point. A specified display area is refreshed by means of modifying video memory data. Regional refresh display is implemented by means of pushing data to a display controller of a video memory. A superposition relationship of a display target is controlled by means of modifying attributes such as a display level and transparency. The display effect is updated by means of setting relevant parameters in the display controller.

In some embodiments, the displaying the target display information in the target area of the display component according to the control instruction further includes: the serial number of the target display information in the storage module is updated.

Specifically, an MCU obtains a locating signal from a touch-control IC, and notifies the TCON that the position, the gallery number and corresponding color information need to be updated. The TCON directly retrieves a local updating block from a flash (which may be customized to be different from the self-contained content of operations) to replace the current update position and to display the same, and in addition, a gallery index number may also be updated.

As an optional solution, the display component includes: a logic board, configured to acquire the target display information of the storage module, as well as receive the control instruction, and convert the control instruction into a driving signal; and a display module, in communication connection with the logic board, and configured to receive the driving signal, and display the target display information of the storage module according to the driving signal. The system further refines the internal structure of the display component.

Specifically, the logic board is a screen driving board, which is configured to receive and parsing image data including pixel point color information (RGB values); processing the data to solve the problems of pixel mapping, bottom plate normalization, and the like; next, segmenting the image into multiple rows and multiple columns of pixel areas, which correspond to the row and column structure of the actual display panel; performing mapping correspondence on the pixels; generating the RGB value of each pixel point according to row and column information and pixel mapping, and outputting the RGB value of each pixel point as pixel display data; and updating RGB pixel data at an appropriate moment according to a related control signal, and controlling the display panel to refresh and display the image content. The display panel updates the display screen according to changes in the received RGB data. By means of continuously refreshing the RGB data and controlling the display panel, it is ensured that the display always displays the latest image content, thereby achieving real-time update and display of the image.

In an optional solution, the control component is further configured to set a communication protocol between the logic board and the control component, so that the control component is in direct communication connection with the display component. The system may further quickly implement the direct communication connection between the control component and the display component.

Specifically, the setting of the communication protocol between the logic board and the control component mainly includes setting a communication mode, performing communication protocol description, setting a communication command, setting a response signal, and performing error processing. The communication mode mainly includes serial communication (SPI, I2C) and parallel communication (dividing channels according to a time sequence). The serial communication is simple and easy to use, but the data transmission efficiency is relatively low, and the parallel communication is on the contrary. The communication protocol description indicates a protocol version, a communication rate, a maximum data packet size and an end signal of both communication parties. It is ensured that the both parties quickly understand and use standard communication modes. All commands for operating the screen driving board should be included in the protocol, and parameters and instructions are attached. The commands include pixel data transmission, display area refresh, parameter setting, and the like. After it is ensured that the command is correctly executed, the screen driving board should generate a related response signal for confirmation, so as to avoid the system working abnormally due to the fact that the command is mistakenly sent and the communication is interrupted. All error conditions that may occur in the communication process should be considered and corresponding processing measures should be performed to ensure the stability of the system. In addition, an error type, an error code and a processing method should be included in the protocol for stipulation.

In yet another optional solution, the target display information includes at least one of the following: virtual keyboard information; cursor information; and temperature information of the control component. The system may further improve the user experience.

Specifically, in practical application, when the user uses a touch-control screen electronic device, a screen virtual keyboard suitable for a screen size often appears, that is, the virtual keyboard information. In addition, in some cases, the user may determine his/her own touch-control position by means of the cursor information. By means of displaying the temperature information of the control component, the user may further be helped to know the usage conditions of the electronic device.

An embodiment of the present application provides an electronic device, including a processor, a memory, and a program stored on the memory and executable on the processor. The device herein may be a server, a PC, a PAD, a mobile phone, or the like.

Apparently, it should be understood by those skilled in the art that the modules or steps of the present application may be implemented by a universal computing apparatus, may be concentrated on a single computing apparatus, or distributed on a network composed of a plurality of computing apparatuses, and may be implemented with program codes executable by the computing apparatus, so that the modules or steps may be stored in a storage apparatus to be executed by the computing apparatus, and in some cases, the illustrated or described steps may be executed in a different order than here, or they are made into individual integrated circuit modules, respectively, or a plurality of modules or steps therein are made as a single integrated circuit module for implementation. As such, the present application is not limited to any particular hardware and software combination.

Those skilled in the art should understand that, the embodiments of the present application may be provided as a method, a system or a computer program product. Accordingly, the present application may adopt the form of a complete hardware embodiment, a complete software embodiment, or an embodiment combining software with hardware. Moreover, the present application may adopt the form of a computer program product which is implemented on one or more computer-usable storage media (including, but not limited to, a magnetic disk memory, a CD-ROM and an optical memory and the like) containing computer-usable program codes.

The present application is described in accordance with flow diagrams and/or block diagrams of the device (system) and the computer program product in the embodiments of the present application. It should be understood that, computer program instructions implement each flow and/or block in the flow diagrams and/or the block diagrams and the combination of the flows and/or blocks in the flow diagrams and/or the block diagrams. These computer program instructions may be provided for a general-purpose computer, a special-purpose computer, an embedded processor or processors of other programmable data processing devices to generate a machine, such that instructions executed by the computers or the processors of the other programmable data processing devices generate apparatuses that are used for implementing specified functions in one or more flows of the flow diagrams and/or one or more blocks of the block diagrams.

These computer program instructions may also be stored in a computer-readable memory that is capable of guiding the computers or the other programmable data processing devices to work in particular manners, such that the instructions stored in the computer-readable memory generate products including instruction apparatuses, and the instruction apparatuses implement the specified functions in one or more flows of the flow diagrams and/or one or more blocks of the block diagrams.

These computer program instructions may also be loaded on the computers or the other programmable data processing devices, so as to execute a series of operation steps on the computers or the other programmable data processing devices to produce processing that is implemented by the computers, such that the instructions executed on the computers or the other programmable data processing devices provide steps for implementing the specified functions in one or more flows of the flow diagrams and/or one or more blocks of the block diagrams.

In a typical configuration, a computing device includes one or more central processing components (CPU), an input/output interface, a network interface and a memory.

The memory may include a volatile memory, a random access memory (RAM) and/or a non-volatile memory and other forms in a computer-readable medium, such as a read-only memory (ROM) or a flash random access memory (flash RAM). The memory is an example of the computer-readable medium.

The computer-readable medium includes non-volatile and volatile, and removable and non-removable media, which may implement information storage by means of any method or technology. The information may be computer-readable instructions, data structures, program modules, or other data. Examples of the storage medium of the computer include, but are not limited to, a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc-read-only memory (CD-ROM), a digital versatile disc (DVD) or other optical memories, a magnetic cassette, a magnetic tape disk memory or other magnetic storage devices or any other non-transmission media, which may be used for storing information that may be accessed by the computing device. According to the definition herein, the computer-readable medium does not include transitory media, such as modulated data signals and carrier waves.

It should also be noted that, the terms “include”, “contain” or any other variants thereof are intended to cover non-exclusive inclusions, such that a process, a commodity or a device including a series of elements not only includes those elements, but also includes other elements that are not explicitly listed, or also includes elements inherent to such a process, commodity or device. If there are no more restrictions, the element defined by the sentence “including a . . . ” does not exclude the existence of other identical elements in the process, the commodity or the device that includes the element.

As can be seen from the above description, the above embodiments of the present application achieve the following technical effects:
1). The display system of the present application includes a control component and a display component, wherein the control component is configured to send a control instruction; and the display component, which is in direct communication connection with the control component, includes a storage module, the storage module is configured to store target display information, and the display component is configured to receive the control instruction sent by the control component, and acquiring and displaying the target display information of the storage module according to the control instruction. The control component directly communicates with the display component, so that the display component directly calls storage information in the storage module and displays the storage information. In this way, the display system does not rely on a graphics card to output data, thereby solving the problem of an image delay affecting the user experience.
2) The electronic device of the present application includes a control component and a display component, wherein the control component is configured to send a control instruction; and the display component, which is in direct communication connection with the control component, includes a storage module, the storage module is configured to store target display information, and the display component is configured to receive the control instruction sent by the control component, and acquiring and displaying the target display information of the storage module according to the control instruction. The control component directly communicates with the display component, so that the display component directly calls storage information in the storage module and displays the storage information. In this way, the display system does not rely on a graphics card to output data, thereby solving the problem of an image delay affecting the user experience.

The above descriptions are only embodiments of the present application, and are not intended to limit the present application. For those skilled in the art, the present application may have various modifications and changes. Any modifications, equivalent replacements, improvements and the like, made within the spirit and principles of the present application, shall all be included in the protection scope of the present application.

1. A display system, comprising:
a control component, configured to send a control instruction; and
a display component, in direct communication connection with the control component, and comprising a storage module, wherein the storage module is configured to store target display information, and the display component is configured to receive the control instruction sent by the control component, and acquire and display the target display information of the storage module according to the control instruction.

2. The system as claimed in claim 1, wherein the system further comprises:
a touch-control component, in communication connection with the control component, and configured to receive a touch-control signal, convert the touch-control signal into touch-control information, and send the touch-control information to the control component, wherein the touch-control information at least comprises touch-control position information.

3. The system as claimed in claim 2, wherein,
the control component is configured to receive the touch-control information, and generate the control instruction on the basis of the touch-control information.

4. The system as claimed in claim 2, wherein acquire and display the target display information of the storage module according to the control instruction comprises:
displaying the target display information in a target area of the display component according to the control instruction, wherein the target area is a projection area, on the display component, of a touch-control area corresponding to the touch-control position information.

5. The system as claimed in claim 4, wherein displaying the target display information in the target area of the display component according to the control instruction comprises:
updating historical display information of the target area of the display component, and displaying the target display information in the target area of the display component.

6. The system as claimed in claim 5, wherein displaying the target display information in the target area of the display component according to the control instruction further comprises:
updating the serial number of the target display information in the storage module.

7. The system as claimed in claim 1, wherein the display component comprises:
a logic board, configured to acquire the target display information of the storage module, as well as receive the control instruction, and convert the control instruction into a driving signal; and
a display module, in communication connection with the logic board, and configured to receive the driving signal, and display the target display information of the storage module according to the driving signal.

8. The system as claimed in claim 1, wherein the display component comprises a logic board, and the control component is further configured to:
set a communication protocol between the logic board and the control component, so that the control component is in direct communication connection with the display component.

9. The system as claimed in claim 1, wherein the target display information comprises at least one of the following:
virtual keyboard information;
cursor information; and
temperature information of the control component.

10. An electronic device, comprising the system as claimed in claim 1.

11. The electronic device as claimed in claim 10, wherein the system further comprises:
a touch-control component, in communication connection with the control component, and configured to receive a touch-control signal, convert the touch-control signal into touch-control information, and send the touch-control information to the control component, wherein the touch-control information at least comprises touch-control position information.

12. The electronic device as claimed in claim 11, wherein,
the control component is configured to receive the touch-control information, and generate the control instruction on the basis of the touch-control information.

13. The electronic device as claimed in claim 11, wherein acquire and display the target display information of the storage module according to the control instruction comprises:
displaying the target display information in a target area of the display component according to the control instruction, wherein the target area is a projection area, on the display component, of a touch-control area corresponding to the touch-control position information.

14. The electronic device as claimed in claim 13, wherein displaying the target display information in the target area of the display component according to the control instruction comprises:
updating historical display information of the target area of the display component, and displaying the target display information in the target area of the display component.

15. The electronic device as claimed in claim 14, wherein displaying the target display information in the target area of the display component according to the control instruction further comprises:
updating the serial number of the target display information in the storage module.

16. The electronic device as claimed in claim 10, wherein the display component comprises:
a logic board, configured to acquire the target display information of the storage module, as well as receive the control instruction, and convert the control instruction into a driving signal; and
a display module, in communication connection with the logic board, and configured to receive the driving signal, and display the target display information of the storage module according to the driving signal.

17. The electronic device as claimed in claim 10, wherein the display component comprises a logic board, and the control component is further configured to:
set a communication protocol between the logic board and the control component, so that the control component is in direct communication connection with the display component.

18. The electronic device as claimed in claim 10, wherein the target display information comprises at least one of the following:
virtual keyboard information;
cursor information; and
temperature information of the control component.
